(19) United States
(12) Patent Application Publication
(10) Pub. No.: US 2009/0218411 A1
(43) Pub. Date: Sep. 3, 2009

(54) WATER SHEET SHOWERHEAD

(76) Inventor: Gorman P. Erik Hansen, Lighthouse Point, FL (US)

Correspondence Address: Allen F. Bennett;Santucci, Priore & Long, LLP, 200 South Andrews, SUITE 100, FORT LAUDERDALE, FL, 33301, US

(21) Appl. No.: 12/203,445

(22) Filed: Sep. 3, 2008

Related U.S. Application Data
(60) Provisional application No. 61/002,134, filed on Nov. 8, 2007.

(51) Int. Cl. B05B 1/00

(52) U.S. Cl. 239/1; 239/520

(57) ABSTRACT

A showerhead produces a wide, sheet-like flow when connected to a water source. Overflow slots guide water from a reservoir and over a spillway guarded by side-dams. A small drainage hole in the reservoir allows drainage and prevents growth of mold within the reservoir. A removable cap on the reservoir allows for insertion of aroma generating material and other water additives for dissolution in the water issuing from the showerhead. A ball swivel connector aerator restrict the flow of water into the reservoir and allow the showerhead to be attached to any compatible water output pipe.

### CROSS-REFERENCE TO RELATED APPLICATIONS

This application claims priority to U.S. Provisional Patent Application No. 61/002,134.

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT DISC APPENDIX

None

### BACKGROUND OF THE INVENTION

1. Field of the Invention

The present invention relates to a device for issuing liquids so that they fall in a sheet. More particularly, the invention provides a showerhead that mimics a small waterfall by providing a downward water stream in a relatively broad, flat sheet so that it provides an effect that is substantially similar to a small waterfall.

2. Prior Art

Showers have long replaced baths as a more expedient and efficient means of hygiene and daily cleansing. Both the efficiency, enjoyability and aesthetic aspects of a shower depend largely on the physical charactersistics of the water as it is applied to the body. Therefore, a plentitude of shower head types have been created to produce various effects and sensations.

U.S. Pat. No. 4,334,328, by Delepine discloses a quiet, flat-topped, wide-mouthed liquid delivery spout. It has flat, rectangular shaped plates placed parallel to one another and curved downward for liquid delivery in sheet form. It has available separate cold and hot water delivery pipes, both of which flow in between the rectangular plates, allowing the top plate to be used as a shelf. It does not disclose a flat spillway over which liquid flows from one source through slots or holes. It also does not disclose a fragrance introducing reservoir with a closing cap, or a downward facing drainage hole. It further does not disclose a screw fitting with ball swivel and aerator to attach to any compatible liquid source.

U.S. Pat. No. 4,513,458, by Delepine discloses a curved sheet formed flow spout for the delivery of liquid. It has a flat sheet with the rear edge curved above the front edge. It has a flat, elongated, narrow delivery slot and chamber perched above the curved sheet mimics in one part, the shape of the concave part of the sheet and in another part, the convex portion of the rear part of the sheet. Each are connected to the other through a u-bend at the top of the chamber. It has two liquid inlets which open into the chamber to deliver liquid. It does not disclose a flat spillway and overflow slots or holes as one seamless unit with side dams running alongside the spillway. It also does not disclose an reservoir that may be accessed through a closable opening and designed to hold fragrance producing material. It further does not have a screw fitting with ball and swivel and aerator for connection to a standard water pipe. It also does not have a small drain-hole at the bottom of the liquid reservoir.

U.S. Pat. No. 4,823,409 by Gaffney, et al., discloses a spout for providing flow of water in the shape of a sheet. It has a screw and O-ring to provide a water tight seal around a pipe. It has an internal reservoir which spills over a weir when full. It has two sheets, both slightly convex and placed horizontally to one another creating a gap through which the water flows when it spills over the weir. It does not disclose an open, flat, spillway with side dams, nor does it disclose a reservoir with a screw cap to insert fragrance producing material with a downward facing drainage hole. It further does not have a screw fitting with ball swivel connector for attachment to an external water pipe.

U.S. Pat. No. 4,912,782 by Robbins discloses a fluid dispensing fixture that produces sheet like emissions. It has a curved tubular arm with a threaded end so that it can be secured to piping. It has a tubular main body connected perpendicular to the arm with outflow ports located on the top of the element. The body contains removable end caps to provide easy access for clog removal. It also has a curved guide member branching out from the top of the main body and slowly curving downward. It does not have an opening allowing for addition of fragrant emitting substances. It also does not have a downward facing drainage hole on the bottom of the reservoir. It further does not disclose a screw fitting with ball swivel and aerator for connection with an external water supply. It also does not have side-dams located on each side of the guide member, nor is the guide member a flat slope.

U.S. Pat. No. 5,249,744 by Ruthenberg is a device that generates waterfalls for swimming pools. It has an inlet box with four sides and an outlet box without a rear or front wall. It has an inlet water pipe which accepts water from the pool. It also has an internal spreader so that the columnar shaped water will be spread into a smooth sheet. The spreader has angular devices which separate the water as it flows in. It does not disclose a shower attachment. It does not disclose a screw fitting with ball swivel and an aerator for use with attachment to a water pipe. It also does not disclose a flat spillway with side-dams or reservoir with a screw top with space for fragrance generating material. It further does not disclose a downward facing drainage hole.

U.S. Pat. No. 5,253,811 by Sieth discloses a spout that provides an extended stream of water in the form of a sheet eventually producing water droplets. It has a curved shield under which sits a liquid conduit connected to a liquid source by threaded bosses. It has a channel inside a nozzle assembly through which water passes. It has an outlet port formed by the end of the liquid channel where the shield extends below the open end of the channel producing a reduced size outlet and shaping the liquid into a sheet. It does not disclose an open, flat spillway with side-dams. It also does not have overflow slots or a reservoir and cap system which allow for the introduction of fragrance producing material. It further does not have a downward facing drainage hole or a screw fitting with a ball swivel and aerator attachable to any compatible pipe.

U.S. Pat. No. 5,274,858 by Berry discloses a pivotable soap dispenser designed to attach to a showerhead. It contains a soap holder mounted to a showerhead using a frame with a pivot. The holder is loaded with soap through a slot. It has mesh screens which allow water to pass through after contacted the soap. It does not disclose a showerhead, it merely discloses an attachment independent of a showerhead. It does not disclose a flat spillway and side dams or a screw top reservoir for holding fragrance producing material. It also does not disclose a drain hole in the reservoir or a screw fitting with ball swivel and aerator for use with any compatible pipe or liquid source.

U.S. Pat. No. 6,006,374, by Winnett et al. discloses a showerhead attachment that also generates and dispenses aroma. It has a cylindrical housing with inlet and outlet ports and contains a smaller dispensing chamber which holds aroma generating material and placed perpendicular through the main chamber. The water flows through the inlet port of the housing then around the dispensing chamber, a small volume of which enters the aroma dispensing chamber. The showerhead has a small outlet port at the end of the aroma dispensing chamber through which some aroma spray is forced so that the aroma collides with the shower wall rather than flow directly onto the bather. It does not disclose a flat spillway for the creation of a waterfall outflow, screw top, or overflow slots, nor a small drain-hole at the bottom of the reservoir. It also does not disclose a reservoir with overflow slots through which the entire volume of water flows over aroma generating material.

U.S. Pat. No. 7,093,775 B1, by Bingham discloses a fragrance dispensing showerhead with a wire mesh screen. It has a central bore so that water may move from the distal to the proximal end through the wire mesh screen. It contains multiple refillable fragrance ejecting mechanisms and a plurality of reservoirs for holding different fragrances; the reservoirs are either directly attached to the showerhead or fastened to but separated from the showerhead and dispensed through a flexible conduit. If attached to the showerhead, the fragrance mechanisms are refillable through the use of a removable filler cap and ejected into the water stream through the use of spring loaded pin containing apertures through which the fragrance is channeled. It also has a threaded inner surface so that it can be removed and placed on another water supply source. It does not disclose a flat spillway for the creation of a waterfall outflow, nor a small drainage hole at the bottom of the apparatus (primarily because water travels from the distal to the proximal end rather than from the water source through a reservoir). It also does not disclose a reservoir where both the fragrance generating material and the water flow simultaneously, rather it discloses fragrance reservoirs which inject said fragrance directly into the water stream. It also does not disclose slotted overflow ports.

It is preferable to have a quiet operating and soothing showerhead. Showerheads typically eject water from various downward facing slots in a manner that causes a displeasing sound and generally abrasive stream. Showerheads which provide a sheet like stream of water present a more pleasing sound as well as a more soothing stream. These showerheads are generally constructed with a slotted, enclosed ejection point or spillway. The liquid flows from the output pipe through the apparatus and out of the slotted ejection point in order to provide a flat sheet of water. Water sheet producing showerheads typically are completely enclosed and use the opening from the enclosure to provide a sheet like water flow. However, this prevents easy addition of aroma generating material to provide an even more soothing bathing experience. The flow of water from existing devices is also typically regulated only by the water flow into the showerhead or spout.

It is therefore desirable to provide a showerhead that provides a water stream as a sheet of water that generates a pleasing sound, a soothing stream and an aesthetically pleasing appearance.

It is also desirable to provide a showerhead that provides an adjustable water stream as a sheet of water.

It is also desirable to provide a showerhead that provides a water stream as a sheet of water to which various materials may be added.

It is also desirable to have a durable, easy to install shower spout that produces a steady sheet of water which also allows for drainage of the reservoir and the option of adding aroma producing material. It is also desirable to provide a means for easily retrofitting an existing water output pipe.

### BRIEF SUMMARY OF THE INVENTION

The present invention provides a showerhead that creates a sheet of water instead of a more typical spray. The flow of the water sheet may be adjusted both by adjusting the water flow and by adjusting the angle of the showerhead. The showerhead also includes a reservoir for applying various beneficial additives to the water sheet. This combines the efficiency and ease of showering with olfactory, tactile and other benefits previously only available while submersing in a bath.

The reservoir has one or more overflow slots that supply water to a spillway. Side-dams direct the water down the spillway and over the edge to create a sheet of water. The reservoir preferably includes a drainage hole to prevent water from sitting stagnant therein and promoting growth of mold and other microorganisms. A screw cap on the end of the reservoir provides access to it and allows bath beads and other bath water additives to be inserted. When in the reservoir, such bath water additives dissolve into the water flowing out of the showerhead. A ball swivel connector allows adjustment of the showerhead's angle and assist in regulating water flow. The ball cap allows for movement of the showerhead to provide the desired stream direction. The invention may be attached to any generally compatible threaded water pipe.

The reservoir is preferably enclosed and extends the length of the spillway. It is large enough to hold various aroma generating materials and water collected from the water output pipe. The reservoir has a removable cap through which the bather may place aroma generating material into the reservoir. The overflow slots are preferably thin so that the aroma, rather than the aroma generating material, moves into the ejecting water supply, and so that other additives dissolve in the water rather than flowing out of the showerhead. Installation is easy, requiring minimal tools, tapes, or adhesives. It preferably has a smooth, flat spillway to provide an even sheet. The showerhead is preferably constructed from a durable, solid, waterproof material, such as metal, that can withstand a steady stream of water.

It is therefore an object of the present invention to provide an easy to install outlet that creates a broad flat stream of a liquid.

It is another object of the invention to provide an option of adding aroma generating material to the reservoir.

The above broadly outlines the more important features of the invention in order that the detailed description thereof that follows may be better understood, and in order that the present contribution to the art may be better appreciated. The features of the invention are more thoroughly described hereinafter and will form the subject matter of the claims.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 is a perspective view of the invention.

FIG. 2 is a side view of the invention.

FIG. 3 is another perspective view of the invention.

FIG. 4 is a perspective view of an alternative embodiment of the invention.

FIG. 5 is a front view of an alternative embodiment of the invention.

FIG. 6 is a front view of an alternative embodiment of the invention.

FIG. 7 is an exploded front view of the invention.

FIG. 8 is a top view of the attachment point.

### DETAILED DESCRIPTION OF THE INVENTION

The invention provides an apparatus for producing a water sheet from a liquid spout, such as a showerhead. It creates an adjustable sheet of water suitable for a shower. It allows various water additives typically not useable in conjunction with a shower to be added to the shower water. These additives, such as bath beads, allow a bather to enjoy olfactory and other benefits typically only available during a time consuming bath in a tub. The present invention allows such additives to be enjoyed during quicker and more efficient showering. This is especially advantageous when a bather typically does not have the available time necessary for a bath.

The invention is especially suited for showers having a threaded spout attachment section commonly found in existing shower stalls and other showering systems. The invention is therefore well suited for retrofitting onto water output pipes already in existence. The invention may be installed by professionals or persons having little or no skill in the art. The invention provides a reservoir with a removable cap giving the bather the option of placing aroma generating or other materials inside. Anyone may use the invention to obtain a soothing and quiet water sheet flow from a standard water output pipe.

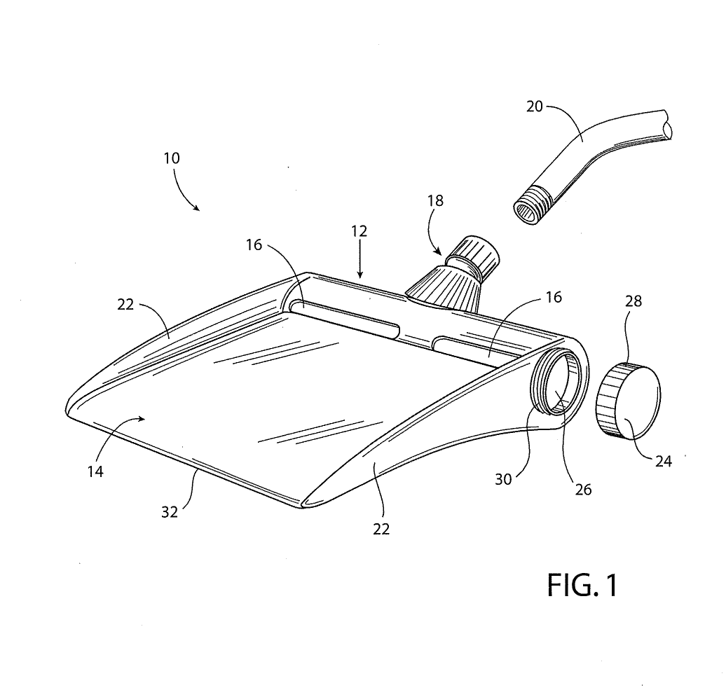

FIG. 1 shows a perspective view of the showerhead 10 of the invention. The showerhead 10 is comprised primarily of a reservoir 12 having an end cap 24, a spillway 14, two side-dams 22 on either side of spillway 14, and a ball swivel connector 18 for connection to a water output pipe 20. Showerhead 10 may be made of any adequately rigid material known in the art and suitable for use with running water, including, but not limited to stainless steel, plastic, ceramic and the like.

When in use, the showerhead 10 is supplied water through the swivel ball aerator 18, which feeds the reservoir 12. An adjustable connector is preferred because it allows the operator to adjust the flow of water off the showerhead. Those skilled in the art will appreciate that it is common to use an adjustable connector with showerheads and that swivel ball connectors and other similar connectors are suitable for the invention.

As water flows into and through reservoir 12, any bath beads or other dissolvable materials rapidly dissolve into the water. Water exits the reservoir 12 through overflow slots 16 in a steady and constant manner. In this embodiment, reservoir 12 is cylindrical. However, the reservoir may be of any shape so long as it provides a chamber for containing materials to be added to the shower water and has suitable volume for an adequate amount of water to dissolve the added materials.

It is generally preferred that the reservoir have a substantially cylindrical shape as the reservoir preferably runs the entire length of the spillway and a circular cross section maximizes volume. The reservoir may have an oval or other shaped cross section and the reservoir may or may not be uniform in shape along its length. Those skilled in the art will appreciate that in some situations it may be desirable to have a reservoir whose shape decreases in proportion to distance from the water source in order to maintain uniform pressure and/or flow. Other preferable shapes for the reservoir include a hexagonal or pentagonal prism optionally including a prismatic extended cupola geometry. However, those skilled in the art will appreciate that it is common for showerheads and other bathroom fixtures to have highly aesthetic designs and that the showerhead of the present invention is highly susceptible to manipulation of its physical shape to accommodate a variety of stylistic tastes, so long as the functional aspects are not substantially frustrated or abrogated.

The reservoir works in conjunction with the overflow slots 16 to create a steady, constant and even flow of water onto spillway 14. This facilitates an even and constant sheet of water flowing off of the showerhead. Overflow slots 16 may be of any of a variety of designs that allow water to flow smoothly from the upper portion of the reservoir onto spillway 14. In this embodiment, overflow slots 16 are comprised of two long horizontal slots of equal length. However, they may be comprised of several small circular holes in a horizontal row or a single slot running the length of the reservoir. Any configuration is suitable so long as the overflow slots 16 evenly distribute the water exiting the reservoir onto the spillway 14 and are sufficiently small or narrow to prevent bath bubbles or other objects in the reservoir from exiting.

The use of the reservoir 12, in addition to providing a means to dissolve water additives also creates a steady, even flow out of the overflow slots 16. The spillway 14 is guarded on either side by side-dams 22. Water flows from overflow slots 16 across spillway 14 and over lip 32. As the water traverses the spillway, it spreads out into a thin sheet. Lip 32 may have any of a variety of geometries to provide different characteristics to the sheet of water as it falls off the spillway 14. Lip 32 may be relatively sharp, or may be rounded and smooth. Those skilled in the art will appreciate that the geometry of lip 32 can have a substantial affect on the flow of the water off spillway 14. Spillway 14 is preferably substantially planar. Concavity, convexity or other curvature in the spillway is generally not preferred as such a design may hamper formation of a water sheet. However, non-planar features may be incorporated into the spillway if desired.

The reservoir 12 includes an end cap 24 that closes over opening 26. Opening 26 allows for the introduction of aroma generating and other materials into the reservoir 12. This provides the user with a relaxing aromatic sensory experience that is both soothing and easy to access for convenient replacement of various materials and bath water additives. Opening 26 also allows for easy cleaning of the reservoir. In this embodiment, cap 24 removably attaches to opening 26 by means of threaded cuff 30 and includes knurled edge 28 to facilitate screwing of the cap 24 onto and off of cuff 30. However, any suitable method of closing opening 26 such that it is substantially water tight may be used with the invention, including, but not limited to, snap fit caps, frictionally engaging plugs, sliding screen door coverings, and the like.

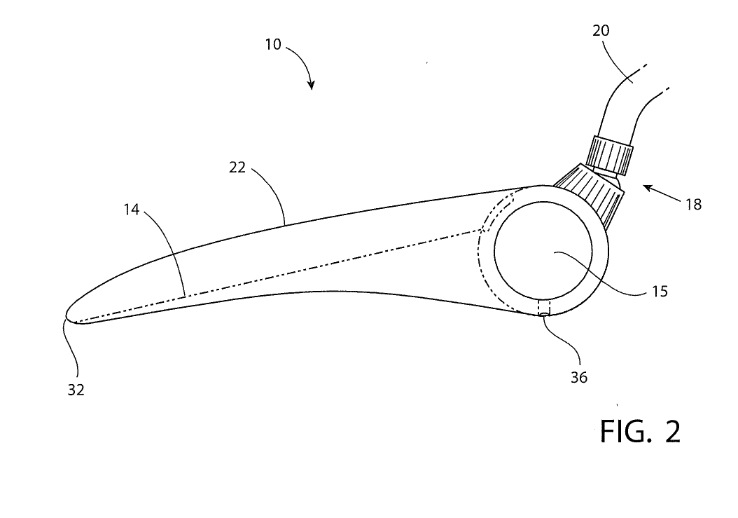

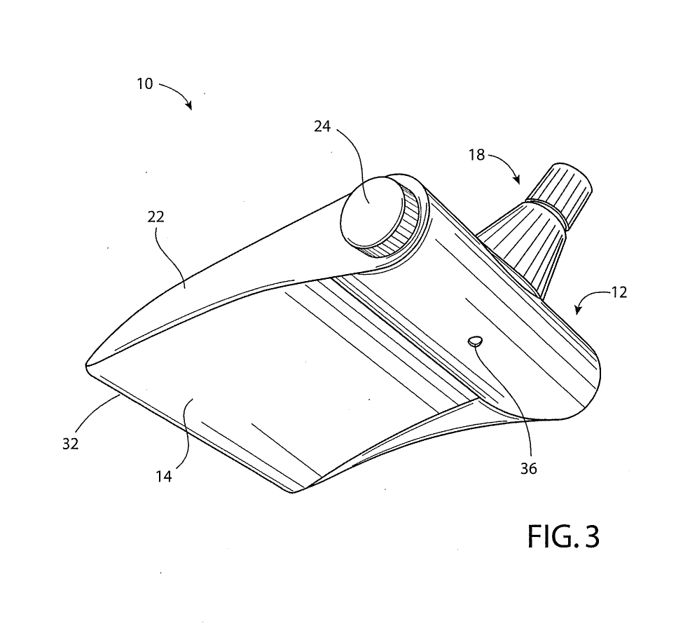

As can be seen in FIGS. 2 and 3, the bottom of the reservoir 12 contains a downward facing drainage hole 36. Drainage hole 36 assists with drainage of water from chamber 15 of reservoir 12 and therefore helps prevent formation of mold or other growths associated with dark, wet places. Those skilled in the art will appreciate the size of the drainage hole should be sufficiently small that water can still build inside the reservoir, yet slowly drain when water is no longer supplied to the reservoir. Alternatively, the drainage hole may be incorporated into the reservoir at a higher location and when the showerhead is not being used it may be adjusted so that the drainage hole faces downward. Inclusion of drainage hole 36 is generally preferred because it requires no action by the user to insure that water will not stagnate within the reservoir. Those skilled in the art will appreciate the downward facing drainage hole 36 may optionally be plugged with a removably attachable drainage cap.

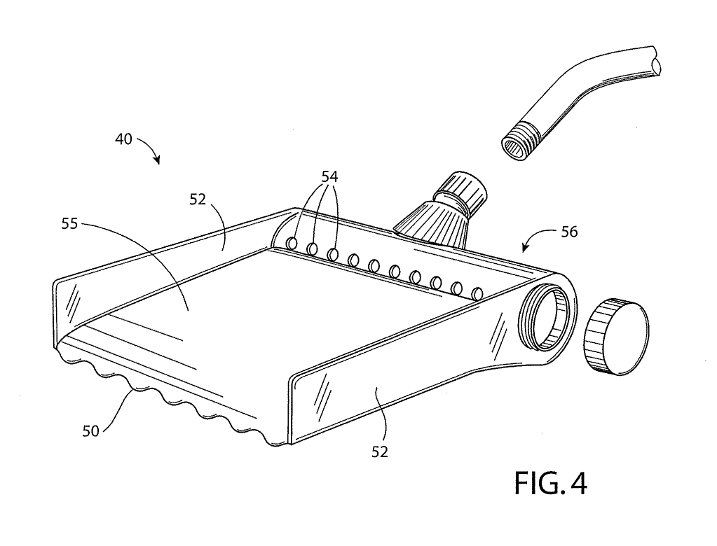

FIGS. 4, 5, and 6 show a few exemplary alternative embodiments of the invention, illustrating only some of the many variations possible within the scope of the invention. FIG. 4 shows an alternative embodiment 40 containing a series of substantially circular overflow holes 54. Overflow holes 54 have the same functionality and purpose as overflow slots 16 of the embodiment shown in FIGS. 1-3. Those skilled in the art will appreciate that overflow holes 54 may be circular or of any other geometry, so long as they adequately allow flow from the upper portion of the reservoir 56 onto the spillway 55. The spillway 55 has a corrugated lip 50 and square side-dams 52. This alternative embodiment is particularly advantageous for providing a full flow rippled effect water sheet. Squared off side-dams 52 illustrate that the side-dams may have any of a variety of geometries so long as they are capable of fulfilling their primary function of preventing water on the spillway from flowing over the sides and directing the water to the lip of the spillway.

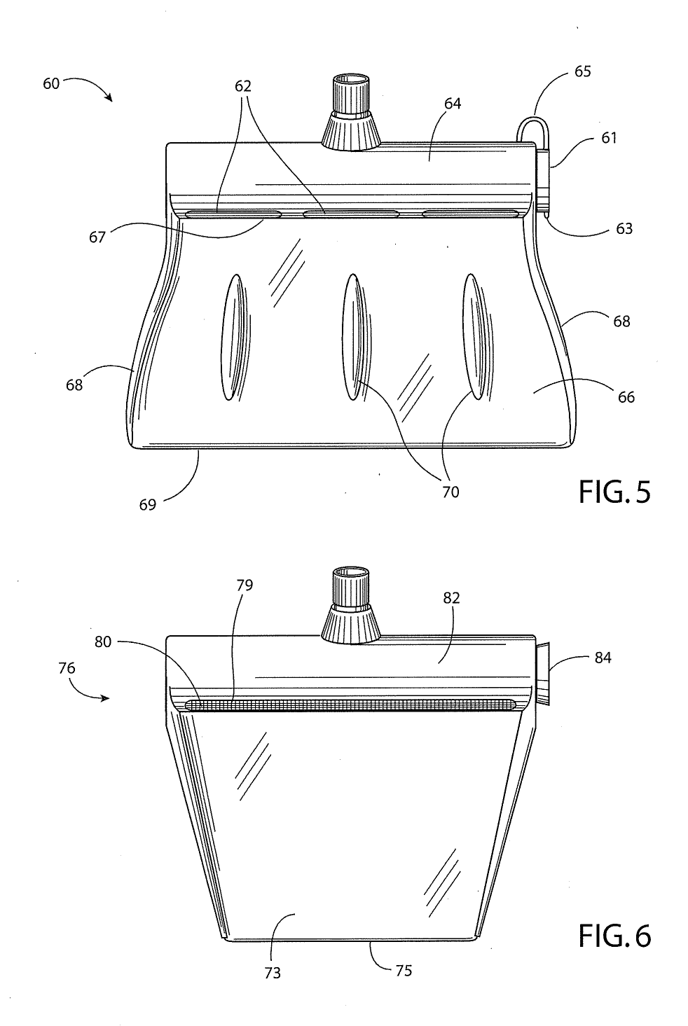

FIG. 5 shows alternative embodiment 60 containing three oval-shaped overflow slots 62 in reservoir 64. Reservoir cap 61 includes a tab 63 for popping cap 61 open and cord 65 permanently attaches cap 61 to the reservoir 64. This prevents misplacement of reservoir cap 61. Typically the reservoir 64 only includes a cap on one end. However, additional caps may be included on the reservoir if desired. It is also possible to place the reservoir cap on the top, bottom or side of the reservoir. It is generally preferred to include the cap on the end of the reservoir. FIG. 5 also has serpentine shaped side-dams 68 along the edges of the spillway 66 that is wider at lip 69 than at the end proximate the reservoir 67. This illustrates that the spillway does not need to be of a rectangular design but may have any of a variety of geometries as desired.

Embodiment 60 also includes three fins 70 that protrude upwardly from spillway 66. These fins 70 are primarily aesthetic in nature and do not substantially alter the flow of water or other liquid over spillway 66. However, if desired, similar fins may be included within the scope of the invention to modify the width of the water sheet flowing over the lip 69 of spillway 66 by making fins 70 adjustable and extensive across the entire length of spillway 66 from proximal end 67 to lip 69.

FIG. 6 shows another embodiment 76 having a trapezoidal spillway 73 that narrows as it approaches the lip 75. Showerhead 76 also includes a single, wide overflow slot 79 that includes a mesh screen 80 to prevent objects in the reservoir 82 from exiting through slot 79. This design may be preferable where the showerhead is intended for use with relatively small additives or materials placed in the reservoir 82. Embodiment 76 also includes a plug 84 at the end of reservoir 82, instead of an end cap. Those skilled in the art will appreciate that there are a variety of mechanisms for removably sealing the reservoir to allow insertion of various materials to influence the properties of the water or other liquid passing through the invention.

Those skilled in the art will appreciate that a very large variety of items may be placed in the reservoir to add a nimiety of qualities to the water. Coloring, scented material, flavoring, therapeutic salts, pH buffers, water hardener and softeners, soaps, oils, exfoliants, moisturizers and a plethora of other materials may be used with the invention. Additionally, the invention may be used for other liquids. It may be desirable to use the invention as a fount for alcoholic beverages and additives thereto, or sundry other liquids that may or may not have substances added to them.

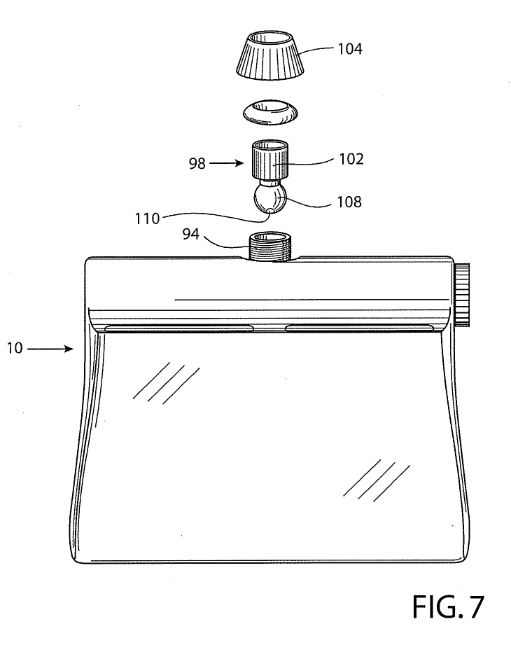

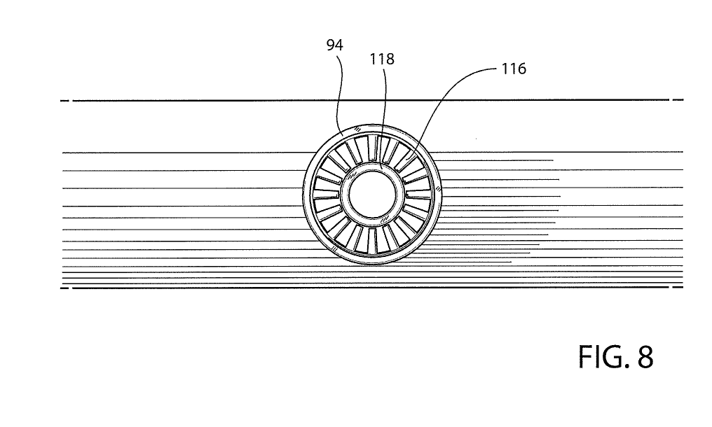

FIGS. 7-8 show the connector 18 between the invention as shown in FIGS. 1-3 and a typical water outlet pipe typically provided in a shower stall or other water outlet. Attached to the top of the reservoir is threaded attachment point 94 for the screw fitting 98 comprising a knurled or otherwise textured body 102 and ball swivel 108, threaded screw cap 104 and conduit 110 which may include an areator. Said threaded attachment point 94 consists of a threaded exterior and internal mechanism 118 for a water-tight seal. A particularly advantageous embodiment consists of a rubber washer 118 and a number of ribs 116 extending from the outer wall of the threaded attachment point 94 that meet and secure the rubber washer 118. Those skilled in the art will appreciate that a water-tight seal may be obtained through a variety of materials including Teflon tape, metal washers, O-rings or the like.

The water output pipe in the embodiments has been consistently shown to connect to the invention near the top of the reservoir. Those skilled in the art will appreciate that the invention may connect to a water pipe at any desired location. Where the invention is used as a fountain or faucet, perhaps for distritbuting beverages, it may be more desirable to have the reservoir connect near the bottom.

Those skilled in the art will appreciate material such as plastic may be used and there are many such materials that could be used in place of a plastic seal such as rubber or latex. Those skilled in the art will also recognize the use of an aerator 110 is particularly advantageous in preserving the planet by aiding the reduction of water consumption and reduction of energy costs of heating water. The bather will enjoy these continued savings while also enjoying the soothing water sheet flow created by the present invention. Additionally, the cap providing access to the interior of the reservoir has been shown as being on the end of the reservoir. Those skilled in the art will appreciate that a sealable opening may be included at just about any point on the reservoir and that there may optionally be more than one access point having a cap or other closing mechanism.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

1. A showerhead comprising:
a reservoir comprising a chamber, at least one overflow slot, at least one drain hole, and a closable opening providing access to the chamber;
a spillway having a lip and two sides and extending outwardly from the reservoir;
two side-dams extending upward from the two sides of the spillway; and,
an adjustable connector in fluid communication with the reservoir.

2. The showerhead of claim 1 wherein the adjustable connector comprises a ball swivel connector.

3. The showerhead of claim 1 wherein the spillway is substantially planar and the lip is straight.

4. The showerhead of claim 1 wherein the spillway comprises a corrugated surface.

5. The showerhead of claim 1 wherein the side-dams are tapered.

6. The showerhead of claim 1 wherein the side-dam has a rectangular shape.

7. The showerhead of claim 1 wherein the at least one overflow slot comprises a plurality of horizontally elongated slots.

8. The showerhead of claim 1 wherein the at least one overflow slot comprises one or more circular holes.

9. The showerhead of claim 1 wherein the at least one overflow slot comprises an opening having a wire mesh.

10. The showerhead of claim 1 wherein the at least one drain hole comprises a single hole with a removably attachable cap.

11. The showerhead of claim 1 wherein the chamber of the reservoir is substantially cynlindrical.

12. The showerhead of claim 1 wherein the chamber of the reservoir is substantially a parallelepiped.

13. The showerhead of claim 1 wherein the chamber of the reservoir has a polygonal cross section.

14. The showerhead of claim 1 wherein the spillway is rectangular.

15. The showerhead of claim 1 wherein the spillway is trapezoidal.

16. A showerhead comprising:
a reservoir comprising a chamber, at least one overflow slot, a drain hole, an opening and a removably attachable end cap;
a planar and rectangular spillway having a straight lip and two sides;
two side-dams extending upward from the two sides of the spillway; and, an adjustable ball swivel;
wherein the adjustable connector comprises a ball swivel connector, an aerator and a threaded knurled screw cap.

17. The showerhead of claim 12 wherein the drain hole comprises a drain hole with a removably attachable cap.

18. The showerhead of claim 12 wherein the plurality of overflow slots comprises elongated, generally oval shaped, openings.

19. A method for creating a water sheet comprising:
supplying water to a reservoir chamber having an upper portion and a lower portion by means of an adjustable connector in fluid communication with a water supply;
Allowing the reservoir to fill with water and flow out therefrom though at least one overflow slots located near the upper portion of the reservoir supply to the point where the water supply spills out of one or more overflow slots such that it the water flows across a spillway;
Channeling the water on the spillway by means of side-walls such that the water flows over a lip at the end of the spillway; and,
providing a drain hole in the bottom of the reservoir chamber and thereby allowing residual water to drain from the reservoir when not in use.

20. The method of claim 17 further comprising providing the reservoir chamber with an opening and a removably attachable end cap; and,
inserting at least one bath enhancing material into the reservoir by means of the opening in the chamber.
